(19) United States
(12) Patent Application Publication
(10) Pub. No.: US 2019/0345779 A1
(43) Pub. Date: Nov. 14, 2019

(54) COIL TUBING BOTTOM HOLE ASSEMBLY WITH REAL TIME DATA STREAM

(71) Applicant: KOBOLD CORPORATION, Calgary (CA)

(72) Inventors: Jeffrey Douglas Martin KENNEDY, Victoria (CA); Emmett Donald Herbert GAMROTH, Victoria (CA); Darryl George Herbert GAMROTH, Victoria (CA)

(21) Appl. No.: 16/481,435

(22) PCT Filed: Jan. 24, 2018
(86) PCT No.: PCT/CA2018/050080

§ 371 Date: Jul. 26, 2019

(30) Foreign Application Priority Data
Jan. 27, 2017 (CA) 2,956,371

(51) Int. Cl. E21B 17/20; E21B 29/00; E21B 47/12; E21B 47/06; E21B 47/01; G01V 3/34; E21B 44/04; E21B 45/00

(52) U.S. Cl. CPC E21B 17/206; E21B 29/002; E21B 47/122; E21B 47/06; E21B 17/02; G01V 3/34; E21B 44/04; E21B 45/00; E21B 47/01

(57) ABSTRACT

Described are various embodiments of a coiled tubing bottom hole assembly system adapted for insertion into a borehole and determining parameters of interest within the borehole. The bottom hole assembly comprises a pressure sensor array for providing differential pressure measurements across the milling assembly, at least one accelerometer for providing acceleration measurements near the bottom hole assembly indicative of at least one of vibration, bit condition, rotational speed and translational parameters and a sensor assembly for providing a measurement of weight-on-bit and applied torque. A data processor adapted to receive inputs from the pressure sensor array, the at least one accelerometer and the sensor assembly. The data processor is also provided and further configured for integrating the differential pressure measurements, the acceleration measurements, the weight-on-bit measurements and torque measurements and providing the information associated with the measurements to a user or control system.

### RELATED APPLICATION

The present application is an International Patent Application which claims benefit of priority to Canadian Patent Application serial number 2,956,371 entitled “COIL TUBING BOTTOM HOLE ASSEMBLY WITH REAL TIME DATA STREAM” filed Jan. 27, 2017, the disclosure of which is herein incorporated by reference.

### FIELD OF THE DISCLOSURE

The present disclosure relates to coiled tubing milling operations and, in particular, to a bottom hole assembly with real time data stream for monitoring downhole operation parameters.

### BACKGROUND

The use of coiled tubing for various well treatment processes such as fracturing, milling, acidizing and fishing is well-known. The advantages in the use of coiled tubing include efficient and safe entry into a well without the necessity of employing complex and costly apparatus such as a workover derrick and the insertion of a drill pipe string which must be individually joined together and related pressure control equipment needed to work on live wells.

Typically, several thousand feet of coiled tubing is wrapped onto a large reel which is mounted on a truck or skid. A tubing injector head, typically employing a chain-track drive, is mounted axially above the wellhead and the tubing is fed to the injector for insertion into the well. The tubing is plastically deformed as it is unrolled from the reel and over a gooseneck guide which positions the tubing along the axis of the wellbore and the injector drive mechanism.

A common application for coiled tubing is milling out plugs or sleeves that have been placed in the borehole. These plugs and sleeves may be placed for testing or isolation purposes and when no longer needed they are milled out to approximately full borehole diameter to allow oil and gas to flow to surface and to allow various zones within the borehole to be productive.

Currently, in coiled tubing operations there is not a precise way of locating the distal end of the tubing in relation to the borehole, so it is impossible to know if the milling bit located on the distal end of the coiled tubing is in contact with the plug to be milled, or if excessive axial force has been applied to the tubing, which will stall out the bit. As a consequence, the efficiencies of the milling operation are very poor, and the cutting rates are far from optimum. An object of the current invention is to optimize the milling operation to reduce time and expense to mill out plugs and sleeves in wellbores, also known as boreholes.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for bottom hole assembly with real time data stream for monitoring downhole operation parameters that overcome some of the drawbacks of known techniques, or at least, provides a useful alternative thereto. Some aspects of this disclosure provide examples such systems and methods.

In accordance with one aspect, there is provided a coiled tubing bottom hole assembly system adapted for insertion into a borehole and determining parameters of interest within the borehole, via the bottom hole assembly. The coiled tubing bottom hole assembly system comprises a pressure sensor array for providing differential pressure measurements across the milling assembly; at least one accelerometer for providing acceleration measurements near the bottom hole assembly indicative of at least one of vibration, bit condition, rotational speed and translational parameters; and a sensor assembly for providing a measurement of weight-on-bit and applied torque. There is further provided a data processor adapted to receive inputs from the pressure sensor array, the at least one accelerometer and the sensor assembly. The data processor is configured for integrating the differential pressure measurements, the acceleration measurements, the weight-on-bit measurements and torque measurements; and for providing information associated with the measurements to a user or control system.

In some exemplary embodiments, the data processor includes a feedback loop operable to maintain a desired weight-on-bit in response to measured parameters of interest.

In some exemplary embodiments, the data processor includes a feedback loop to maintain a desired bit torque of a milling bit in operable communication with the bottom hole assembly system in response to measured parameters of interest.

In some exemplary embodiments, the bottom hole assembly further comprises a bit advancement mechanism wherein, in some embodiments the bit advancement mechanism is controlled by the data processor. In some embodiments, the bit advancement mechanism is actuated by a hydraulic circuit where the hydraulic circuit comprises a hydraulic pump module, one or more pistons, and one or more fluid conveying passages. In some embodiments, the bit advancement mechanism is actuated by a linear actuator.

In some embodiments, the pressure sensor array further comprises at least one pressure transducer capable of measuring transient annular pressure of the borehole adjacent to the bottom hole assembly.

In some embodiments, the pressure sensor array further comprises at least one pressure transducer capable of measuring transient circulation pressure of a fluid within the bottom hole assembly.

In some embodiments, the parameters of interest are used to the adjust weight-on-bit and/or adjust a fluid injection rate. In some embodiments, the fluid is the motive fluid.

In some embodiments, the accelerometer is multi-axis such that the parameters of at least bit condition, milling penetration rate and bit rotational speed may be inferred by means of data processing. In some embodiments, the at least one accelerometer is a gyroscope.

In some embodiments, the data processor provides the information associated with the measurements in real time.

In some embodiments, the sensor assembly comprises at least one strain gauge, where the strain gauge is adapted to measure axial load and torsional load. In some embodiments, the sensor assembly comprises at least one strain gauge, where the strain gauge is adapted to measure axial load. Furthermore, in some embodiments, the sensor assembly comprises at least one strain gauge, where the strain gauge is adapted to measure torsional load.

In some embodiments, the sensor assembly comprises at least one temperature gauge.

In yet another aspect, there is provided a method for optimizing milling parameters within the borehole when using a milling assembly in the borehole. The method comprises analyzing borehole conditions and adjusting the milling parameters including the steps of:
a) obtaining information from a bottom hole assembly system as defined in any one of claims 1 to 20;
b) processing the information in real time using one or more of the data processors;
c) transmitting at least some of the information to surface; and
d) adjusting the milling parameters of interest in response to the borehole conditions.

In some embodiment of the methods, the information is provided remotely from the bottom hole assembly in real time. Furthermore, in some embodiments of the method, the information is processed in real time and provided to the control system so as to automate the milling parameters.

In some embodiments of the methods, the control system includes a feedback loop configured for providing optimal milling parameters.

In some embodiments of the method, the information is displayed to the user or provided to the control system in real time, whereas in other embodiments, the information displayed to the user or provided to the control system with a delay.

In some embodiments of the method, the milling parameters consist of applied axial force, bit rotational speed, motive fluid flow rate through the milling assembly, motive fluid pressure, borehole pressure, and advancement rate of a bit. In some embodiments, the advancement rate of the bit is regulated by a bit advancement mechanism. In some embodiments, the bit advancement mechanism is actuated by hydraulic pressure acting on a piston and wherein the hydraulic pressure is regulated by the feedback loop. In some embodiments, the bit advancement mechanism is further regulated a hydraulic pump module. In some embodiments, the bit advancement mechanism is actuated by an electrically-operated linear actuator and wherein the linear actuator is regulated by the feedback loop.

In yet another aspect, there is provided a friction reducing tool adapted for conveying in a borehole wherein the friction reducing tool:
a) produces vibrations in response to a motive fluid flow therethrough; and
b) is activatable and deactivatable in response to a signal from a bottom hole assembly system as defined in herein provided from the surface from either the user or the control system manually or as part of an automatic optimization system.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 shows a sectional side plan view of an exemplary configuration of an embodiment of the bottom hole assembly, including a mud motor and bit, for lowering into a borehole;

FIG. 2 shows a schematic view of an embodiment of the equipment uphole of the bottom hole assembly and coiled tubing;

FIG. 3 is a perspective view of an exemplary embodiment of the bottom hole assembly;

FIG. 4 is a perspective view of an exemplary embodiment of the bottom hole assembly showing interior components;

FIG. 5 is a perspective view of an exemplary embodiment of the end of the bottom hole assembly;

FIG. 6 is a sectional view of an exemplary embodiment of the bottom hole assembly;

FIG. 7 is a schematic side plan view of an exemplary embodiment of a tool chain, including an exemplary embodiment of a bottom hole assembly inserted within a borehole without the added perforations;

FIG. 8 is a schematic side plan view of an exemplary embodiment of a tool chain, including an exemplary embodiment of a bottom hole assembly inserted within a borehole with the added perforations;

FIGS. 9 to 11 are perspective views of various exemplary embodiments of a stroker tool (linear actuator); and

FIG. 12 is a sectional view of an exemplary embodiment of a friction reducing tool.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

The systems and methods described herein provide, in accordance with different embodiments, different examples in which a coiled-tubing milling assembly used during a milling operation comprises a bottom hole assembly that is operable to measure in real-time a plurality of physical parameters from a plurality of sensors and process from these measurements the value of parameters of interest indicative of the efficiency of the milling operation. The parameters of interest are defined as parameters that may be used to characterize the efficiency of the milling operation. These may be deduced from raw measurements of physical properties of the milling assembly and borehole condition, recorded from a plurality of sensors, such vibrations, temperature, pressure and mechanical strain and stress. These parameters of interest may include, but are not limited to: the bit condition, such as information about whether the bit is dull, whether it has stalled, whether it has come into contact with an obstacle, the average debris size, its rotational speed and the weight-on-bit; the condition and rotational speed of the mud motor; the advancement rate of the bit, the motive fluid flow rate through the assembly, the motive fluid pressure, the borehole pressure and any other parameter characterizing the effectiveness of the cutting rate. Knowledge of these parameters of interest may then be used to determine changes to the operation parameters of the plurality of tools used during the milling process in a way to adjust its effectiveness and optimize the milling operation.

Accordingly, the embodiments described therein seek to improve or at least provide a useful alternative to current practices, namely in some embodiments by providing a process and system in which there is no need to wait after a coiled-tubing milling operation is over to determine whether the current parameters of interest are optimal but rather, whereby measurements are made downhole in real-time are used in an in-situ optimization of the milling operation.

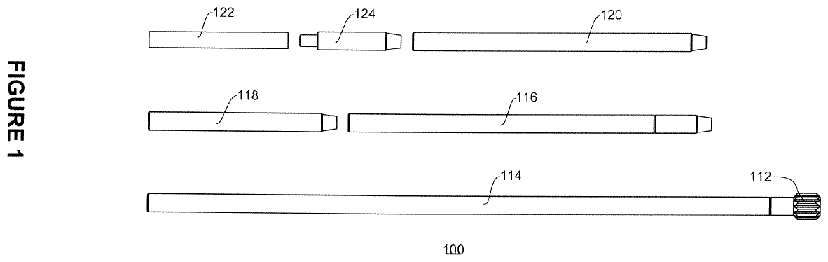

With reference to FIG. 1, and in accordance with one embodiment, a configuration of connected tools (or “subs”) and other items that are run into a borehole in the earth at the end of a coiled tubing system are shown. Collectively, this configuration is referred to as milling assembly 100.

From the distal end-is a bit 112, which may be a tricone bit, diamond bit, or any other bit that is well known in the art. Different bits may be used depending upon the types of material that are to be milled out.

Shown next is a rotational power source 114 for the bit, typically a progressive cavity motor, or “mud motor”. This is a well-known device that converts the flow and pressure of the motive fluid into rotational motion used to turn the drilling or milling bit, depending upon the desired operation. The choice and pairing of mud motor and bit would be known to those skilled in the art. The mud motor 114 is driven by a motive fluid pumped from surface, often water with an additive package. Other fluids known in the art such as drilling muds, inert gases, diesel fuel, or commingled liquids and gases may be used. Other types of sources of rotation may also be used, such as hydraulic motors, or submersible electric motors.

The motorhead assembly 116 and hydraulic jar 118 are well known items and are commonly used in conjunction with coiled tubing operations. The motor head assembly 116 consists of a safety valve, typically a double flapper check valve, a release tool, and circulating sub. Optionally, a coil connector, a device to connect the end of the coiled tubing to other tools, may also be included. An example is a dimple connecter, but other configurations are known. It may be desirable to run a release tool as part of the motorhead assembly 116 so that the motor 114 and the mill 112 may be detached and left in the borehole if they become stuck.

A hydraulic release tool (not shown) may be actuated by circulating a ball down to the release tool and pressuring up to shift a sleeve which in turn allows a collet to flex so that dogs may uncouple from an undercut in the body. The ball must be small enough to pass through the coiled tubing 122, the connector 124, the bottom hole assembly 120, the hydraulic jar 118, and the double flapper check valves (not shown). A tension release is actuated by pulling the release into tension by a predetermined amount. If the release tool in the motorhead assembly 116 is actuated, the double flapper check valves maintain well control by preventing wellbore fluids from flowing to surface up the coiled tubing.

A circulation sub (not shown) may also be incorporated into the motorhead assembly 116 that allows for circulation out the side using flow ports (not shown). These flow ports are actuated by circulating a ball (not shown) down to a seat in a shiftable sleeve (not shown) and pressuring up to slide a sleeve that in turn exposes flow ports in the side of the body. The ball must be small enough to pass through the coiled tubing bottom hole assembly 120, the connector 124, the bottom hole assembly 120, the optional jar 118, the double flapper check valves, and the release tool.

Hydraulic Jar 118 are well known and are designed to provide impact forces in an axial direction to help release the coiled tubing if it should be come stuck in the hole. Jars exert an impact load at the distal end of the coiled tubing which is not dampened by coiled tubing stretch and friction if a similar upward or downward load were to be applied at surface using the coiled tubing injector.

The E-coil 122 consists of an outer armor section, an inner insulation and armor section, and at the center, one or more conductor cables for carrying power and/or information to/from the surface. As is well known in the art, this cable may be made from copper or carbon-based conductors and other similar materials and combinations. In some embodiments, a fiber optic cable may also be included. The conductor cable is surrounded by a protective sheath that protects it from abrasion and helps to carry any tension forces. Due to the large length and small diameter of the cable, the data transmission rates and the amount of power transmitted is limited at the present time.

The connector sub 124 attaches the coil tubing string (via the E-coil 122) to the bottom hole assembly 120. In some embodiments, the connector sub 124 incorporates an electric release mechanism, such that in the event of the bottom hole assembly 120 becoming stuck in hole, it may be released from the coil and left behind, while the coiled tubing can be retrieved to surface. In the current art, if a ball can't be circulated to the release tool, or the predetermined over pull can't be achieved at the distal end of the coiled tubing, the coiled tubing must be cut off at surface and the distal end left in the hole. Workover rigs are then used to retrieve the coiled tubing where possible. This is an expensive, time consuming, and destructive process, requiring the entire reel of coiled tubing required to be scrapped and a replacement sourced before well service operations can be resumed.

The bottom hole assembly 120 is the sub that contains a plurality of sensors to collect various parameters of interest that relate to the milling and borehole conditions, such as pressure, temperature, the vibrational signature (i.e. vibration amplitudes and directions), and the strain and stress experienced by the coiled tubing and connected tools (i.e. the strain/stress amplitudes and directions). Other parameters may also be considered. These sensors may be functionally connected to the E-coil 122 to transmit data intermittently or in real-time.

In some embodiments, the plurality of sensors comprises a pressure sensor array. This array contains multiple pressure sensors at different locations on the bottom hole assembly 120 such that the differential fluid pressure across the milling assembly 100 may be measured. The differential pressure is used to determine the condition of the mud motor 114, and may determine if the motor has stalled due to excessive axial force being applied by the coiled tubing. The pressure sensors may also be used for determining the pressures within the annulus of the borehole, and within the coiled tubing.

The bottom hole assembly 120 may further comprise accelerometers placed on multiple axis to measure the vibrational signature of the bit as it is turning and milling a plug or other obstruction. Parameters of interest may be deduced from this signature, such if the bit has contacted the obstruction to be milled, if it has stalled, or if the cutting rate is in an optimal range. Further parameters that can be determined from this signature are the bit condition, such as if it is getting dull, debris size from the cuttings coming off the obstruction being milled, cutting effectiveness of the bit and the rotational speed of the bit. A further parameter than may be deduced is the condition of the mud motor, as excessive vibration may indicate a worn motor. By sampling various frequencies, the condition of different parts of the milling assembly 100 may be monitored as has been well understood for predictive maintenance of large rotating machinery for several years.

Other sensors contained within the bottom hole assembly 120 may also include temperature sensors to measure the fluid and borehole temperatures at bottom hole conditions.

In some embodiments, the plurality of sensors may also include strain gauges such that the weight-on-bit can be measured, as well as the axial stress or force within the coiled tubing. In some embodiments, multiple strain gauges are used in different orientations such that both forces or stresses in axial and torsional directions can be measured. These strain gauges, combined with the accelerometers, may be used, in some embodiments, to determine the advancement rate of the coiled tubing within the borehole. The weight-on-bit is an important parameter to know if contact is being made with the obstruction to be milled, and in combination with measuring rotational speed can determine if the bit is actually contacting the obstruction to be milled out. A frequent cause of non-productive time on coiled tubing operations currently is there is no effective way to determine when the bit is contacting the obstruction, so the bit could be turning and not doing any milling. Similarly, it could be pressed so hard against the obstruction that the mud motor stalls and cannot turn the bit, so again no milling is being accomplished. Alternatively, the milling bit may not be engaged sufficiently with the obstruction; this condition leads to premature bit wear and, potential damage to the stator in the motor due to over speeding, and inefficient milling. Similar to metalworking operations using conventional machine tools, there is an optimum combination of rotational speed and feed rate of the cutting surface against the item to be machined to produce an optimum cutting rate and tool life.

Other sensors, such as strain gauges, known in the art may be used to measure the forces on the coiled tubing and the bit.

As mentioned above, the amount of data and power that can be transmitted via the E-coil 122 to and from the surface is often may be limited by various factors. Owing to these factors, some embodiments of the bottom hole assembly 120 may further comprise an integrated processor (not shown). This integrated processor may be a digital processing device (e.g. hardware processor with embedded software/firmware). This processor may be used so that processing of data coming from the plurality of sensors is done, at least in part, locally downhole, and in some embodiments in real-time. Moreover, the integrated processor may also be operatively connected to the E-coil and the data or processed information may be transmitted to the surface to be displayed for an operator at a control panel.

In some embodiments, the data processed in real time using the integrated processor may be used to adjust at least one parameter of interest to optimize the efficiency of the milling operation, as soon as possible. This optimization may also be done intermittently or continuously, in real-time, insuring an optimum cutting rate and tool life. The processor may also be functionally connected to other subs or tools within the milling assembly and operable to control them in order to optimize the process in real-time. Certain examples of parameters of interest that may be changed to optimize the milling process include but are not limited to: the motive fluid flow rate and pressure (which controls the rotational speed of the mud motor and bit), the weight-on-the bit (which controls the axial force applied to the coiled tubing by the injector head) and the borehole pressure and the advancement rate of the bit.

In some embodiments, adjustments and optimizations of the parameters may be done manually by operators on the surface in response to the displayed information transmitted to surface by the bottom hole assembly's integrated processor, with a similar objective to achieve the optimum cutting rate. In yet another embodiment, when there is no connection to surface, the downhole processed data may be recorded and viewed at a later time to determine if nonproductive milling time could have been reduced.

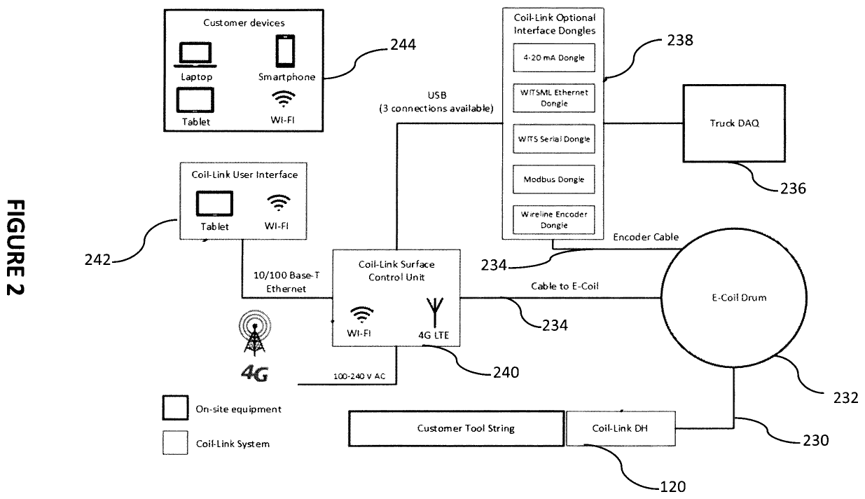

With reference to FIG. 2, and in accordance with one exemplary embodiment, a series of systems used to relay information between the bottom hole assembly 120 inside the borehole and the surface is shown. The downhole bottom hole assembly 120, as discussed previously, is connected, through the connector sub 124, to the E-coil 122. The E-coil 122 extends all the way up to the surface to the E-coil Drum 232, on which it is wounded. As shown in FIG. 2, external cables may be connected to the conductor cables contained within the E-coil at this end. In some embodiments, an encoder cable 230 or a cable 234 may be used to functionally link the E-coil to a data collection and processing device 236 (i.e. data acquisition unit (DAQ)), where the data extracted from the bottom hole assembly 120 and relayed through the E-coil 122 may be collected and processed. The data may also be transmitted remotely by using interface devices such as the surface control unit 240 or an optional interface dongle 238. This transmission may be done wirelessly or by wired means to display devices 242, or to an external computer for further use and process. In some embodiments, the data may also be displayed on a remote device 244, which may be a customer device on location, or in another location such as an office in a faraway city. The remote device 244 may include laptop computers, tablets, smart phones or the like. Other embodiments may have the processed information sent to a remote viewing location, such as a head office in a distant city for evaluation by Engineers and other personnel such as the clients.

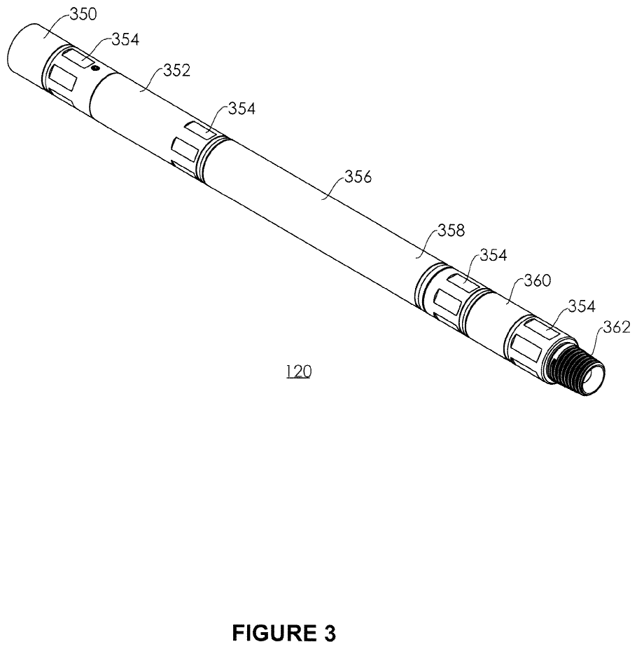

FIG. 3 shows an external view of an exemplary embodiment of bottom hole assembly 120. We see an anchor packoff 350, attached to a sensor chassis 352. A sensor chassis sheath 356 is shown threadingly engaged to the chassis 352 and covering the electronics. Embedded within the sheath 356 is a pressure port 358 that allows fluid communication to the pressure transducer inside the bottom hole assembly 120. On the distal end is a crossover sub 360 that allows the bottom hole assembly 120 to be attached to other subs or pipe via standard oilfield threads 362. Wrench flats 354 are provided at appropriate points to facilitate assembly and disassembly of the tool.

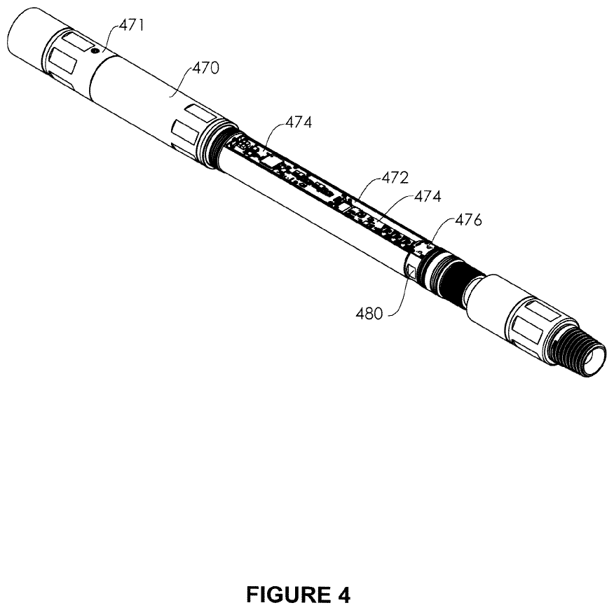

In FIG. 4, a similar exemplary the bottom hole assembly 120 is shown again but with the outer sheath 356 removed to better show the interior elements. We see that a pressure bulkhead section 470 is provided at the uphole portion of the tool to provide isolation between the electrical cavity 472 and the fluids that flow through the center of the tool to ensure that the electronics operate in a dry environment. Within the electrical cavity 472 are printed circuit boards 474 that contain circuits for data gathering, processing and transmission. Pressure transducers 476 are also included within the electrical cavity to measure the downhole pressure of the annulus. A mounting surface 480 is provided upon which strain gauges are mounted to enable weight-on-bit, applied torque and other parameters to be measured and fed to the data collection and processing circuits. This mounting surface 480 is covered by the sheath 356 and is in the dry area. In conjunction with the pressure bulkhead 470 is an anchor pack off sub 471 where the wireline can attach to the tool.

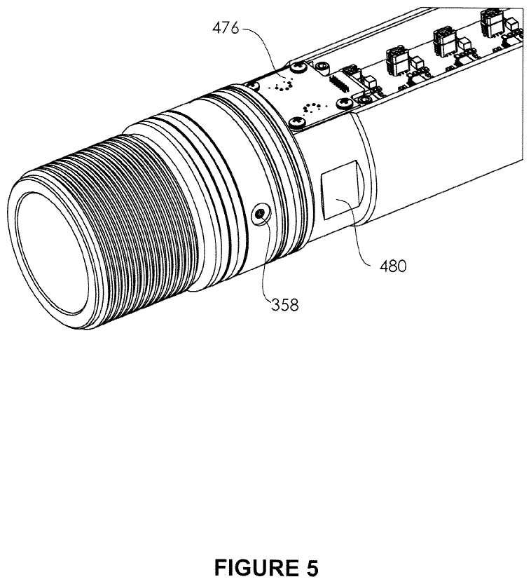

FIG. 5 shows the distal end of a similar embodiment of the bottom hole assembly 120 from FIGS. 3 and 4. We can see with greater detail the strain gauge mounting surface 480, pressure port 358 and pressure transducer 476.

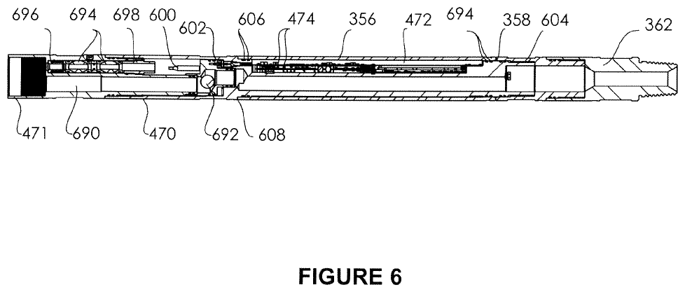

FIG. 6 is a cross sectional view of the exemplary embodiment of the bottom hole assembly 120 from FIGS. 3 to 5. It is shown that the pressure bulkhead section 470 has a fluid passage 690 for passing motive fluid, as well as allowing balls to pass through. Balls are used in many downhole tools to perform certain functions, such as opening sliding sleeves or ports. A 15/16″ ball 692 is shown to illustrate that a ball can pass through the bottom hole assembly 120. Within the pressure bulkhead 470 is a wireline type packoff 694 for providing a fluid seal between the receiving bore 696 and the E-coil, or other information and/or power conductor (not shown). A packoff compression screw 698 compresses the packing elements to form a leak tight seal. The anchor elements (not shown) anchor the wireline to the receiving bore 696, such that it will not pull out under tension. A bulkhead fitting (not shown), such as manufactured by Kemlon is used to pass the conductor out of the receiving bore 696 and into the electrical cavity 472. The conductor passes through the bulkhead fitting 600 and attaches to contacts 602. From there, contact is made to the appropriate places on the circuit boards 474. The outer sheath 356 attaches to the pressure bulkhead 470 through threads 604, and provides a fluid tight joint through seals 606. The outer sheath 356 does not engage the pressure bulkhead 470, a gap 608 is left between the outer sheath 356 and the pressure bulkhead 470 to ensure that the strain gauges will record accurate measurements of axial load and torque applied to the drill bit.

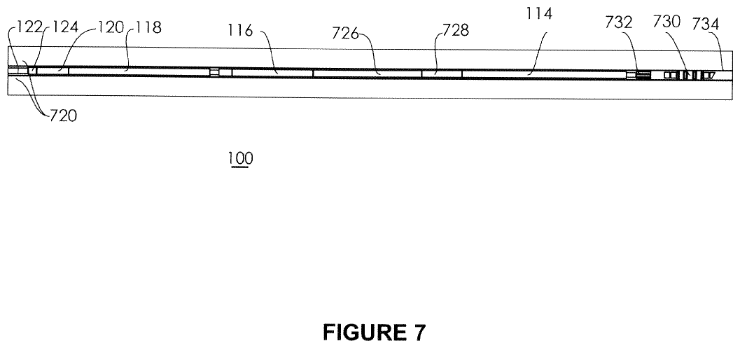

FIG. 7 shows another exemplary embodiment of the whole milling assembly 100 inserted within a subterranean formation 720. In this embodiment, from the uphole side are shown the e-coil 122, the coiled tubing connector bottom hole assembly 124, the bottom hole assembly 120, the hydraulic jar 118, followed by the motor head assembly 116, a friction reducing tool 726, an optional stroker tool (linear actuator) 728, the mud motor 114 and a milling bit 732, respectively.

The friction reducing tool 726 is a vibrating and shaking device that causes pressure pulsations within the coiled tubing. These pressure pulsations cause the coiled tubing to vibrate and its entire length. This vibration breaks the static friction between the coiled tubing and the adjacent wall of the wellbore so that coiled tubing can be inserted further into the wellbore. The friction reducing tool is shown located between the motor 114 and the motorhead assembly 116, but it may be positioned anywhere in the milling assembly. Those skilled in art will appreciate that the order of components is not fixed, and may be varied with components added or deleted according to operating conditions. Moreover, in some embodiments, for example in horizontal boreholes, one would use such friction reducing tool in place of the hydraulic jar.

The bridge plug 730 is the object to be removed by the bit 732 and the other tools described previously collaborate to optimize the milling operation. Bridge plugs are well known, and can take many different configurations and materials. Bridge plugs are generally set in wellbores that are cased with casing 734 but variations are commercially available for use in open hole.

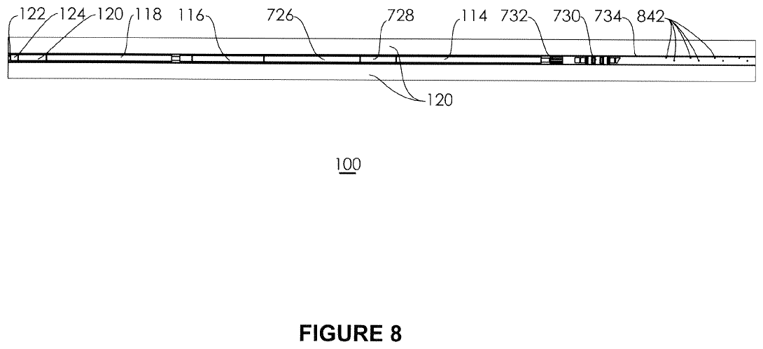

FIG. 8 includes many of the components outlined in FIG. 7, with the addition of the perforations 842.

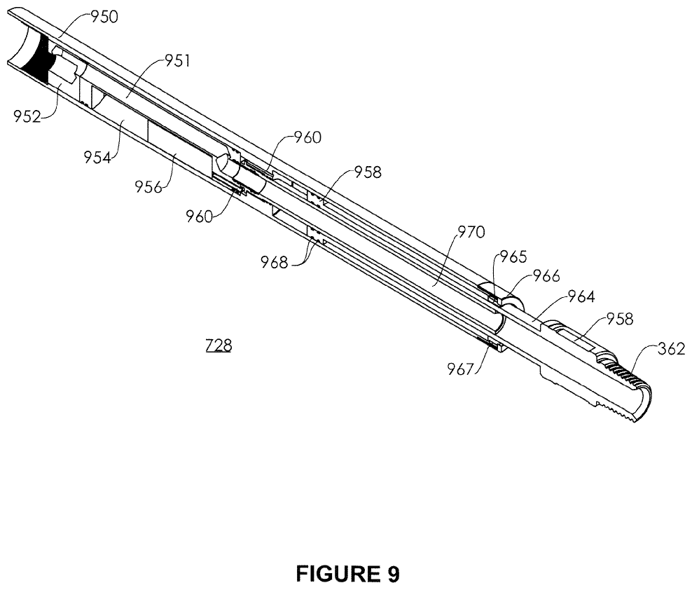

In FIG. 9, an exemplary embodiment of the stroker tool (linear actuator) 728 is shown, where it is hydraulically-actuated. Within an outer body housing 950 is a flow diverter 952 which diverts fluid around the hydraulic reservoir 954 and hydraulic pump module 956. The fluid flowing through the passage 951 is motive fluid. The hydraulic system used for actuating the piston 960 within the housing 950 is an isolated system using hydraulic oil, or other suitable fluid, and this oil does not come into contact with the motive fluid flowing the tool through passage 951. From hydraulic reservoir 954, the fluid is pressurized and pumped by the pump module 956. The pump module is controlled by the data collection and processing devices 236, from surface, or by an integral processor (not shown). Known means of communication between the downhole components are used, such as local area radio or wireless communications protocols. Communication to surface is by the means described in FIG. 2. From the pump module 956 the fluid flows through hydraulic passages 960 to act on the piston 958 urging it in a downhole direction. The distal end of the piston 958 had standard oilfield threads 362 to connect the mud motor and bit as shown in FIGS. 7 and 8. By means of manipulating the output pressure of the pump module 956, the force acting on the piston 958 and thus the milling bit 732 in contact with the obstacle, typically a bridge plug 730, to be milled may be adjusted. By means of manipulating the force on bit, milling parameters such as cutting rate can be optimized.

To counter rotational forces from the bit, the anti-rotation surfaces 964 are not round, but a geometric shape, such as hexagonal. Other suitable shapes may also be used. A retaining nut 966 is used to retain a follower 965 that fits between the retaining nut 966 and the anti-rotation surfaces 964. The inner surface of the follower 965 is adapted to be substantially the same shape as the piston 958 the outer surface is adapted to engage the inner surface of the retaining nut 966. In other embodiments, two followers may also be used instead of just one. A keyway 967 is cut into the retaining nut 966 and into each follower, locking the follower to the retaining nut with a key placed into the keyway 967 and preventing rotation of the follower 965 relative to the retaining nut 966.

Piston rings 968 provide a fluid tight seal between the piston and the outer housing 950, and the inner tube 970. The sealing surface of the piston rings 568 engagement is round, unlike the anti-rotation surfaces 964 that are non-round.

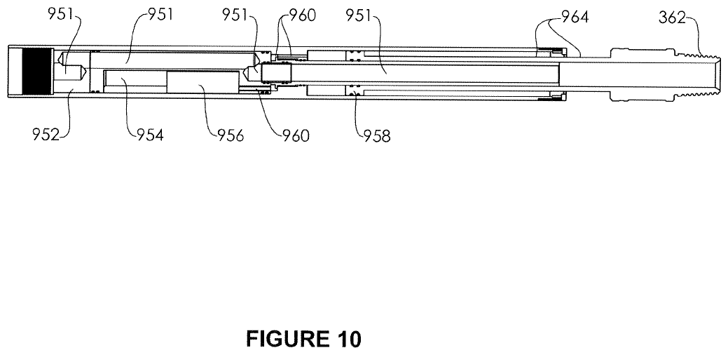

In FIG. 10, the motive fluid passages 951 are shown in greater detail. The piston 958 can be urged to the right in the orientation of the drawing under hydraulic force generated by the hydraulic pump module 956. The piston 958 can be retracted by opening a check valve within the pump module 956 and the fluid can flow back to the hydraulic reservoir 954 by fore applied to the distal end of the piston 958. This force can be applied by the injector on surface urging the coiled tubing further into the hole, and the piston and further equipment attached to threads 362 abutting a bridge plug 730 or any other obstruction encountered downhole.

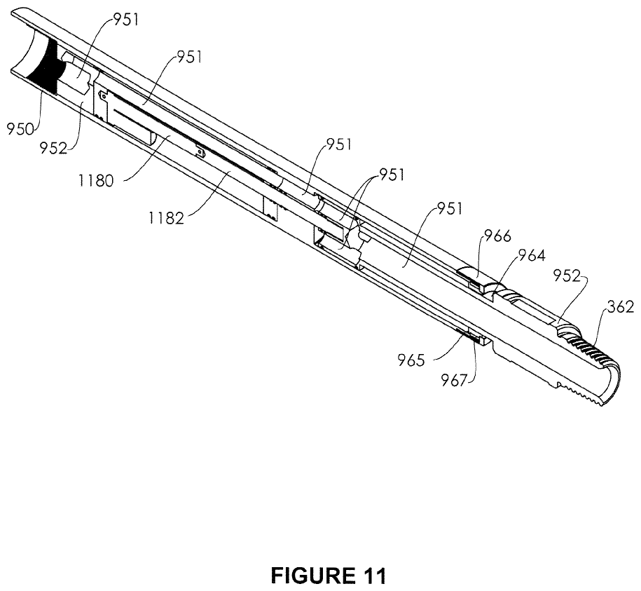

An alternative embodiment of the stroker tool (linear actuator) 728 is detailed in FIG. 11. In place of the hydraulic means to displace the piston, an electric linear actuator module 1180 is provided. Connected to the electric linear actuator 1180 is an actuator shaft 1182 that moves in an axial direction. The shaft 1182 engages a piston 958, such that the piston 1184 can be extended or retracted by the linear actuator 1180 to change the applied weight-on-bit. In this embodiment, the anti-rotational features function identically to the hydraulic embodiment described above.

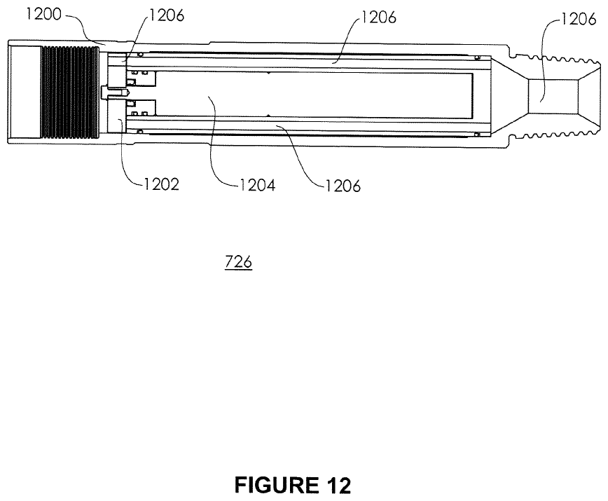

With reference to FIG. 12, an exemplary embodiment of the friction reducing tool 726, is shown. Within an outer housing 1200 is a rotor 1202. The rotor 1202 rotates as it is driven by an electric motor and controller assembly 1204 and holes in the rotor allow or block the passage of fluid through the at least one fluid passage 1206. The effect of the rotating rotor 1202 is to act as a flow interrupter such that the fluid exiting the tool pulses, rather than flowing continuously. The pulses of fluid create vibrations, especially since the at least one fluid flow passage(s) 1206 are not located on the axis of the tool, so the fluid impinging on the end of the tool section to exit on axis further enhances the vibration effect. As described hereinabove, the vibrations are desirable to enhance the penetration of the coiled tubing into the horizontal section of a wellbore in a subterranean formation, and are also useful to help release the coiled tubing if it should become stuck in the wellbore. Due to the energy consumption and possible fatigue induced failures, it is desirable to have the vibration effect only operate when needed, rather than continuously. The electric controller assembly 1204 is in contact with the other data processor located on adjacent tools by similar means to the other data gathering and processing devices, and in contact with the surface if desired by the same means as the other devices described hereinabove.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A coiled tubing bottom hole assembly system adapted for insertion into a borehole and determining parameters of interest within said borehole, the bottom hole assembly comprising:
(a) a pressure sensor array for providing differential pressure measurements across the milling assembly;
(b) at least one accelerometer for providing acceleration measurements near the bottom hole assembly indicative of at least one of vibration, bit condition, rotational speed and translational parameters;
(c) a sensor assembly for providing a measurement of weight-on-bit and applied torque; and
(d) a data processor adapted to receive inputs from said pressure sensor array, said at least one accelerometer and said sensor assembly;
said data processor configured for integrating said differential pressure measurements, said acceleration measurements, said weight-on-bit measurements and torque measurements; and
said data processor being further configured for providing information associated with said measurements to a user or control system.

2. The coiled tubing bottom hole assembly system as defined in claim 1, wherein said data processor includes a feedback loop operable to maintain a desired weight-on-bit in response to measured parameters of interest.

3. The coiled tubing bottom hole assembly system as defined in claim 1, wherein said data processor includes a feedback loop to maintain a desired bit torque of a milling bit in operable communication with said bottom hole assembly system in response to measured parameters of interest.

4. The coiled tubing bottom hole assembly system as defined in claim 1, wherein said bottom hole assembly further comprises a bit advancement mechanism.

5. The coiled tubing bottom hole assembly system as defined in claim 4, wherein said bit advancement mechanism is controlled by said data processor.

6. The coiled tubing bottom hole assembly system as defined in claim 4, wherein said bit advancement mechanism is actuated by a hydraulic circuit.

7. The coiled tubing bottom hole assembly system as defined in claim 6, wherein said hydraulic circuit comprises a hydraulic pump module, one or more pistons, and one or more fluid conveying passages.

8. The coiled tubing bottom hole assembly system as defined in claim 4, wherein said bit advancement mechanism is actuated by a linear actuator.

9. The coiled tubing bottom hole assembly system as defined in claim 1, wherein said pressure sensor array further comprises at least one pressure transducer capable of measuring transient annular pressure of the borehole adjacent to the bottom hole assembly.

10. The coiled tubing bottom hole assembly system as defined in claim 1, wherein said pressure sensor array further comprises at least one pressure transducer capable of measuring transient circulation pressure of a fluid within the bottom hole assembly.

11. The coiled tubing bottom hole assembly system as defined in claim 1, wherein said parameters of interest are used to said adjust weight-on-bit.

12. The coiled tubing bottom hole assembly system as defined in claim 1, wherein said parameters of interest are used to adjust a fluid injection rate.

13. The coiled tubing bottom hole assembly system as defined in claim 10, wherein said fluid is the motive fluid.

14. The coiled tubing bottom hole assembly system as defined in claim 1, wherein said at least one accelerometer is multi-axis such that the parameters of at least bit condition, milling penetration rate and bit rotational speed may be inferred by means of data processing.

15. The coiled tubing bottom hole assembly system as defined in claim 1, wherein said at least one accelerometer is a gyroscope.

16. The coiled tubing bottom hole assembly system as defined in claim 1, wherein said data processor provides said information associated with said measurements in real time.

17. The coiled tubing bottom hole assembly system as defined in claim 1, wherein said sensor assembly comprises at least one strain gauge, said stain gauge being adapted to measure axial load and torsional load.

18. The coiled tubing bottom hole assembly system as defined in claim 1, wherein said sensor assembly comprises at least one strain gauge, said strain gauge being adapted to measure axial load.

19. The coiled tubing bottom hole assembly system as defined in claim 1, wherein said sensor assembly comprises at least one strain gauge, said strain gauge being adapted to measure torsional load.

20. The coiled tubing bottom hole assembly system as defined in claim 1, wherein said sensor assembly comprises at least one temperature gauge.

21. A method for optimizing milling parameters within the borehole when using a milling assembly in said borehole, said method comprising analyzing borehole conditions and adjusting the milling parameters including the steps of:
(a) obtaining information from a bottom hole assembly system as defined in any one of claims 1 to 20;
(b) processing said information in real time using one or more of said data processors;
(c) transmitting at least some of said information to surface; and
(d) adjusting the milling parameters of interest in response to the borehole conditions.

22. The method for optimizing milling parameters within the borehole as defined in claim 21, wherein said information is provided remotely from the bottom hole assembly in real time.

23. The method for optimizing milling parameters within the borehole as defined in claim 21, wherein said information is provided to said control system so as to automate said milling parameters.

24. The method for optimizing milling parameters within the borehole as defined in claim 23, wherein said control system includes a feedback loop configured for providing optimal milling parameters.

25. The method for optimizing milling parameters within the borehole as defined in claim 21, wherein the information is displayed to said user or provided to said control system in real time.

26. The method for optimizing milling parameters within the borehole as defined in claim 21, wherein the information is displayed to said user or provided to said control system with a delay.

27. The method for optimizing milling parameters within the borehole as defined in claim 21, wherein said milling parameters consist of applied axial force, bit rotational speed, motive fluid flow rate through the milling assembly, motive fluid pressure, borehole pressure, and advancement rate of a bit.

28. The method for optimizing milling parameters within the borehole as defined in claim 27, wherein said advancement rate of the bit is regulated by a bit advancement mechanism.

29. The method for optimizing milling parameters within the borehole as defined in claim 28, wherein the bit advancement mechanism is actuated by hydraulic pressure acting on a piston and wherein the hydraulic pressure is regulated by the feedback loop.

30. The method for optimizing milling parameters within the borehole as defined in claim 29, wherein the bit advancement mechanism is further regulated a hydraulic pump module.

31. The method for optimizing milling parameters within the borehole as defined in claim 28, wherein the bit advancement mechanism is actuated by an electrically-operated linear actuator and wherein the linear actuator is regulated by the feedback loop.

32. A friction reducing tool adapted for conveying in a borehole wherein the friction reducing tool:
(a) produces vibrations in response to a motive fluid flow therethrough; and
(b) is activatable and deactivatable in response to a signal from a bottom hole assembly system as defined in any one of claims 1 to 20 provided from the surface from either said user or said control system manually or as part of an automatic optimization system.
